(19) United States
(12) Patent Application Publication
(10) Pub. No.: US 2010/0032952 A1
(43) Pub. Date: Feb. 11, 2010

(54) TURBINE GENERATOR HAVING DIRECT MAGNETIC GEAR DRIVE

(76) Inventors: Gareth P. Hatch, East Dundee, IL (US); Benjamin C. Plamp, Elk Grove Village, IL (US)

Correspondence Address: RICHARD A. FAGIN, P.O. BOX 1247, RICHMOND, TX, 77406-1247, US

(21) Appl. No.: 12/537,367

(22) Filed: Aug. 7, 2009

Related U.S. Application Data
(60) Provisional application No. 61/087,183, filed on Aug. 8, 2008.

(51) Int. Cl. F03B 13/00; H02K 7/10

(52) U.S. Cl. 290/54; 310/83

(57) ABSTRACT

A turbine operated electric generator includes a turbine and a magnetic gear unit rotationally coupled at an input thereof to at least one of an inner rim of the turbine and an outer rim of the turbine. An output of the magnetic gear unit is configured to operate an electric generator. The magnetic gear unit includes magnets configured to at least one of increase a rotation speed at the output with respect to the input speed and inversely change a torque at the output with respect to the input and decrease the output speed with respect to the input speed and inversely change the torque.

### CROSS-REFERENCE TO RELATED APPLICATIONS

Priority is claimed from U.S. Provisional Application No. 61/087,183 filed on Aug. 8, 2008.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of electric power generation. More specifically, the invention relates to devices for driving electric generators using wind or water as the prime mover.

2. Background Art

Wind or water operated turbines are known in the art for driving electric generators. Typically, such turbines are coupled to the electric generator using a gear system to increase the rotation speed of the generator because the rotation speed of the turbine is typically not sufficient to operate the generator.

Gear systems known in the art for use with turbine powered generators are typically mechanically implemented. Mechanical gear systems are subject to power loss due to friction and require substantial maintenance.

There exists a need for gear systems for turbine powered electric generators that do not require mechanical gear systems to increase rotation speed with respect to the turbine.

### SUMMARY OF THE INVENTION

A turbine operated electric generator according to one aspect of the invention includes a turbine and a magnetic gear unit rotationally coupled at an input thereof to a turbine. An output of the magnetic gear unit is configured to operate an electric generator. The magnetic gear unit includes magnets configured to at least one of increase a rotation speed at the output with respect to the input speed and inversely change a torque at the output with respect to the input and decrease the output speed with respect to the input speed and inversely change the torque.

A method for generating electric power according to another aspect of the invention includes moving a fluid past a turbine to cause rotation thereof. The turbine rotation is coupled to an input of a magnetic gear unit. Output of the magnetic gear is coupled to an electric generator to cause rotation thereof at least one of a greater speed than a rotation speed of the turbine and inversely related torque and a lower speed than the rotation speed of the turbine and inversely related torque.

Other aspects and advantages of the invention will be apparent from the following description and the appended claims.

### BRIEF DESCRIPTION OF THE DRAWINGS

FIG. 1 is a side view of one example of a direct drive, magnetically geared generator.

FIG. 2 is an oblique view of the example generator shown in FIG. 1.

FIG. 3 is an end view of the example generator shown FIG. 1.

FIG. 4 is a detail view of an inner magnetic gear and stator for the generator shown in FIG. 1.

FIG. 5 is a detailed side view of an outer magnetic gear and stator for the generator shown in FIG. 1.

FIG. 6 is detailed oblique view of the outer magnetic gear and stator for the generator shown in FIG. 1.

FIG. 7 shows another example generator wherein an inner magnetic gear unit includes a magnet configured to rotate cycloidally.

### DETAILED DESCRIPTION

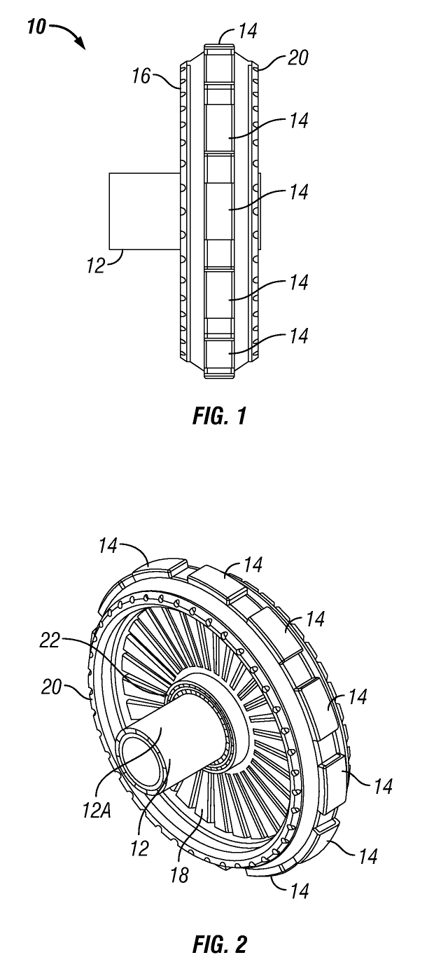

FIG. 1 is a side view of an example direct drive, magnetically geared electric generator. The present example generator 10 includes an inner stator 12, which may include a plurality of wire coils (FIG. 4) arranged to convert movement of magnets (explained below) proximate thereto into electric power. An inner magnetic gear unit (22 in FIG. 2) is rotationally coupled at its input to an inner edge of a turbine (18 in FIG. 2) and its output is rotationally coupled to the magnets that excite the wire coils in the inner stator. One arrangement of magnets will be further explained below with reference to FIG. 4. Electrical connections to the coils can be conventional and are omitted from the drawings for clarity.

An outer magnetic gear unit 20 may be rotationally coupled at its input to the outer edge of the turbine (18 in FIG. 2). The outer magnetic gear unit 20 couples rotation of the turbine (18 FIG. 2) to magnets (45 in FIG. 6) disposed rotationally proximate an outer stator 14, which also may include a plurality of wire coils configured to convert movement of the magnets (FIG. 6) into electrical power. The inner stator 12 and the outer stator 14 may each be disposed in a suitable housing (not shown).

The example generator shown in side view in FIG. 1 is shown in oblique view in FIG. 2, wherein the turbine 18 and the inner magnetic gear unit 22 can be observed. The turbine 18 may have a number of blades, blade pitch, and inner and outer diameter thereof selected to convert motion of fluid, such as water, into rotational motion. The particular dimensions for the turbine blades, and the number of blades will depend primarily on the expected velocity range of the fluid, as will be appreciated by those skilled in the art. It is contemplated that the turbine 18 will be configured to enable rotation and generation of sufficient torque in relatively low fluid velocity to operate the respective electric generation devices rotationally coupled to the turbine 18. As will be further explained below, rotation of the turbine 18 may be rotationally coupled through the respective inner 22 and outer 20 magnetic gear units to magnets configured to excite the coils in the inner 12 and outer 14 stators to generate electric power. The purpose of the inner 22 and outer 20 magnetic gear units is generally to change the rotational speed of the coil excitation magnets (explained below) disposed proximate the respective stators 12, 14, with respect to the rotational speed of the turbine 18. It is thus possible to design the turbine, for example, to rotate at very low drive fluid speeds, while causing the excitation magnets to move at sufficient rotational speed to generate electric power.

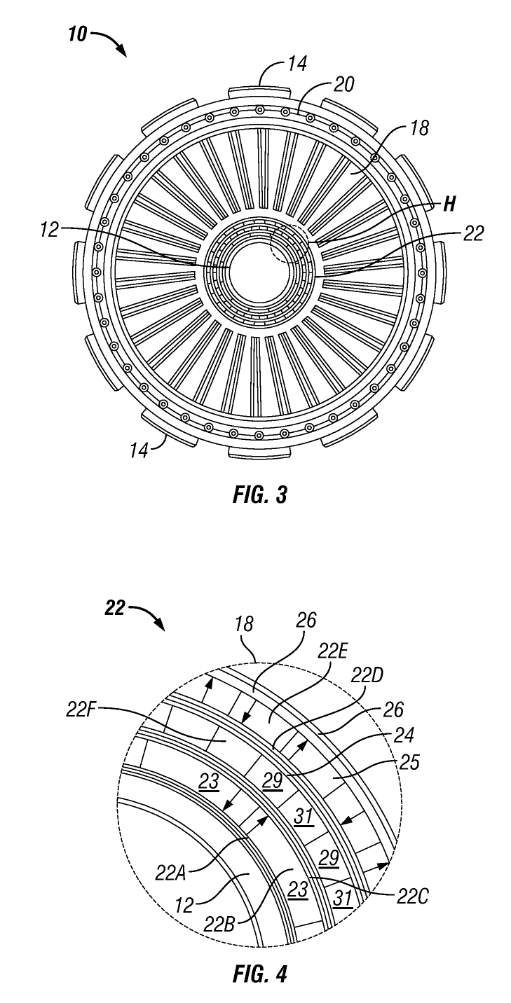

FIG. 3 shows an end view of the generator of FIG. 1. The generator 10 includes, as explained with reference to FIG. 1, and as shown successively radially outwardly, the inner stator 12, inner magnetic gear unit 22, the turbine 18, the outer magnetic gear unit 20 and the outer stator 14.

FIG. 4 shows parts of the inner magnetic gear unit 22, inner stator 12 and turbine 18 in more detail. The inner magnetic gear unit 22 may include an input gear magnet assembly 22E coupled to an interior surface of an input gear housing 26. The input gear housing 26 may be made from magnetically permeable material such as steel or ferrite, and is configured to couple rotation of the turbine 18 to input magnets 25 forming the outer magnet assembly 22E and to form a magnetic flux closure for the input magnet assembly 22E. The input magnets 25 may be in the shape of circumferential segments and magnetically polarized, in the present example, in alternate directions radially from the center of the inner gear unit 22. When placed side by side, the magnets 25 may thus form an annular ring. The input gear assembly 22E may include a fluid tight outer seal 22D on the interior surface thereof. Located laterally inwardly from the outer seal 22D is a magnetic pole assembly 22F. The magnetic pole assembly 22F may include a plurality of magnetically permeable pole shoes 29 in the shape of circumferential segments having suitable inner and outer radii of curvature to fit rotationally inside the outer seal 22D and outside of an intermediate seal 22C. The pole shoes 29 may be disposed alternatingly between similarly arcuate-shaped non-magnetic segments 31. The non magnetic segments 31 may be dimensionally similar to the pole shoes 31 and when placed alternatingly with the pole shoes 29 as shown in FIG. 4 may form an annular ring. An output magnet assembly 22B may be disposed laterally inwardly from the intermediate seal 22C. The output magnet assembly 22B may include a plurality of magnets 23 shaped as circumferential segments and, in the present example, radially alternatingly polarized as shown in FIG. 4. The output magnets 23 in the output magnet assembly 22B may engage an inner seal 22A. The output magnets 23, when disposed circumferentially adjacent to each other, can form an annular ring. The output magnets 23 are caused to rotate proximate the inner stator 12 by the action of the input magnets 25 and pole shoes 29, thereby causing generation of electrical power. Depending on the relative numbers of magnets and pole shoes, the rotation rate of the output magnets 23 may be at a selected ratio with respect to the rotation rate of the input magnets 25 caused by rotation of the turbine (18 in FIG. 2). For implementations of the generator that are to be used in low fluid velocity environments, it is contemplated that the gear ratio of the magnetic gear unit will be such that the output magnets 23 rotate at a relatively high speed relative to the input magnets 25.

Other examples may include that the magnets in the inner magnetic gear unit 22 in both the input magnet assembly 22E and the output magnet assembly 22B may be in a quadrature arrangement, that is, each magnet may have magnetic polarization direction offset from that the preceding magnet by 90 degrees. Successive magnets are each oriented to have magnetic polarization 90 degrees offset (in the same rotational direction) from that of the preceding magnet.

As explained above, the number of magnets 23 in the output magnet assembly 22B, the number of pole shoes 29, and the number of magnets 25 in the input magnet assembly 22E may be selected to result in a predetermined rotational speed ratio between the turbine 18 and the output magnets 23. The output torque will be approximately inversely related to the ratio of input rotational speed to output rotational speed.

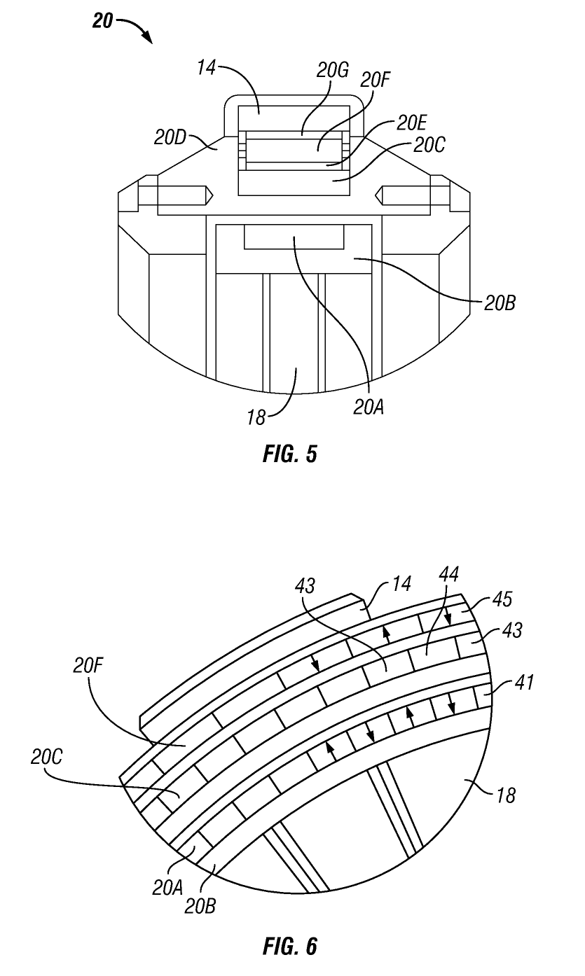

FIG. 5 shows a detailed side view of the outer magnetic gear unit 20 and outer stator 14. The outer gear assembly 20 may include a structural element 20B such as a ring made from magnetically permeable material that couples rotation of the turbine 18 to an input magnet assembly 20A and may act as a magnetic flux closure. Other components of the outer magnetic gear unit 20 may be disposed in a suitably formed housing 20D. Such components may include a magnetic pole assembly 20C disposed laterally externally to the input magnet assembly 20A. An inner seal 20E may engage the outer surface of the magnetic pole assembly 20C. An output magnet assembly 20F may be disposed externally to and engage an outer surface of the inner seal 20E. The output magnet assembly 20F may be rotatably sealed on its exterior by an outer seal 20G. Rotational movement of the output magnet assembly 20F proximate the outer stator 14 results in generation of electrical power by excitation of the wire coils therein.

The components of the outer magnetic gear unit 20 explained above with reference to FIG. 5 are shown in more detail in FIG. 6. The input magnet assembly 20A may include a plurality of alternatingly polarized, circumferential segment shaped input magnets 41. As with the inner magnetic gear unit magnet assemblies, when arranged circumferentially adjacent to each other, the input magnets 41 form an annular ring. The magnetic pole assembly 20C may include a plurality of magnetically permeable pole shoes 43 formed in the shape of circumferential segments disposed alternatingly with non magnetic elements 44. The output magnet assembly 20F may include a plurality of circumferential segment shaped, alternatingly polarized magnets 45. The number of the input magnets 41, pole shoes 43 and output magnets 45 may be selected to provide a predetermined rotation speed ratio between the turbine 18 and the outer magnet assembly 20F. The output torque will be approximately inversely related to the ratio of input rotational speed to output rotational speed.

In the foregoing example, the magnets may be made from a permanent magnet material such as neodymium iron boron or samarium cobalt. Other permanent magnet materials known in the art may also be used.

Some examples may include that the magnets in the inner magnetic gear unit 20 in both the input magnet assembly 20A and the output magnet assembly 20F may be in a quadrature arrangement, that is, each magnet may have magnetic polarization direction offset from that the preceding magnet by 90 degrees. Successive magnets are each oriented to have magnetic polarization 90 degrees offset (in the same rotational direction) from that of the preceding magnet.

The example magnetically geared, turbine operated electric generator includes stators and magnetic gear units both internally and externally to the turbine. Other examples may include a stator only radially internally to the turbine. Still other examples may include a stator only radially externally to the turbine.

A turbine operated electric generator according to the various aspects of the invention may provide the capability of operating in a wide range of drive fluid speeds while operating one or more electric generators at suitable rotations speeds that are different from the turbine speed. Such change in rotation speed is performed without the need for mechanical gears, which may reduce construction and maintenance costs, and reduce risk of failure of the gear unit.

The examples described above have, for each of the inner magnetic gear unit and the outer magnetic gear unit, concentric input and output magnetic gear assemblies. In another example, either or both of the inner magnetic gear unit and the outer magnetic gear unit may have non-concentrically rotating inner and outer magnet assemblies. In such examples a combination of eccentrics and other devices may be used to cause either the input magnet assembly or the output magnet assembly to rotate in a cycloid pattern, while the other magnet assembly rotates on its axis. Such cycloidal movement of one magnet assembly while the other magnet assembly rotates on its axis may result in a higher gear ratio as contrasted with the previous examples having concentrically rotating input and output magnet assemblies. Such high gear ratio may be used advantageously to cause high speed of motion of the respective magnet assembly (outer magnet assembly of outer gear unit, or inner magnet assembly of inner gear unit) with respect to the associated stator. Such cycloid motion arrangement is described, for example, in F. T. Joergensen, T. O. Andersen, P. O. Rasmussen, The cycloid permanent magnetic gear, IEEE Transactions on Industry Applications, vol. 44, no. 6, 1659-1665 (November-December 2008).

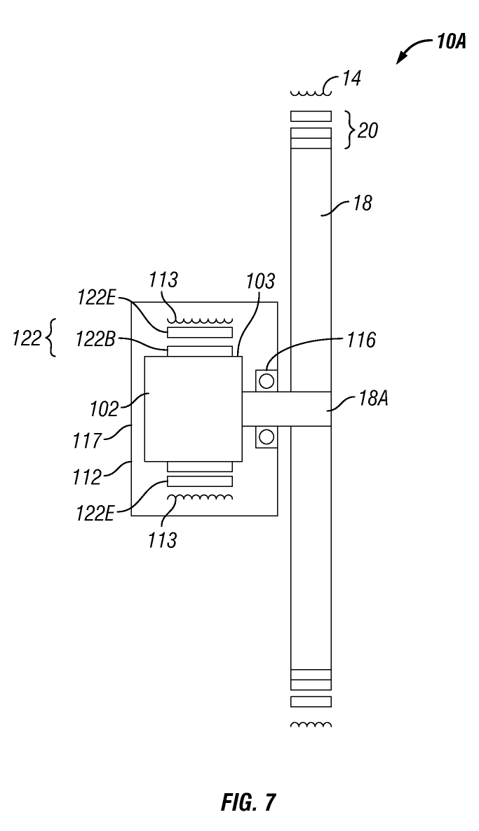

An example generator including a cycloidal magnetic gear is shown in cross-section in FIG. 7. In the present example, the generator 10A may include a turbine 18, outer magnetic gear unit 20 and outer stator (including generator coils or windings) substantially as explained with reference to FIGS. 1 through 6. In the present example, however, the turbine 18 may include a center shaft 18A which may be rotatably supported by a bearing 116 in the housing 117 of the inner stator 112. The turbine shaft 18A may be rotationally coupled to the input of an eccentric drive 102. The eccentric drive may be configured such that its exterior rotates cycloidally. Thus the outer surface of the eccentric drive 102 will rotate with respect to the axis of the shaft 18A, and the central axis of the eccentric drive 102 will precess about the axis of the shaft 18A. The inner magnetic gear unit 122 in the present example may be configured to have an input magnet assembly 122B disposed on the outer surface 103 of the eccentric drive 102. Thus, the input magnet assembly 122B will rotate cycloidally just as the outer surface 103 of the eccentric drive 102. The input magnet assembly may be configured similarly to those of the previous examples. The output magnet assembly 122E may be configured similarly to those explained with reference to the previous examples and may be disposed coaxially with the axis of the shaft 18A. An annular space between the input magnet assembly 122B and the output magnet assembly 122E in the inner magnetic gear unit 122 is shown exaggerated (larger gap on the bottom) to illustrate the cycloidal motion of the input magnet assembly 122B with respect to the output magnet assembly 122E. The output magnet assembly 122E may be disposed proximate the stator coils 113 as in the previous examples to generate electric power by the rotational motion of the output magnet assembly 122E by the stator coils 113. As explained in the Joergensen et al. publication cited above, using such a cycloidal magnetic gear unit may enable a large gear ratio, thereby enabling the output magnet assembly 122E to rotate at relatively high speed even with relatively low turbine speed. Although shown only on the inner magnetic gear unit 122 in FIG. 7, it will be appreciated by those skilled in the art that a similar eccentric drive arrangement could be made for the outer magnetic gear unit.

A turbine operated electric generator according to the various aspects of the invention may have reduced maintenance, less susceptibility to failure, and may operate in a wider range of drive fluid velocities than mechanically geared turbine generators known in the art.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A turbine operated electric generator comprising:
a turbine; and
at least one magnetic gear unit rotationally coupled at an input thereof to the turbine, an output of the magnetic gear unit configured to operate an electric generator, the magnetic gear unit having magnets configured to at least one of increase a rotation speed at the output with respect to the input speed and inversely change a torque at the output with respect to the input and decrease the output speed with respect to the input speed and inversely change the torque.

2. The generator of claim 1 wherein the electric generator comprises wire coils disposed proximate magnets in the output of the magnetic gear unit.

3. The generator of claim 1 further comprising a magnetic gear unit rotationally coupled at an input thereof to each of an inner and an outer rim of the turbine, wherein an output of each magnetic gear unit is configured to operate an electric generator.

4. The generator of claim 1 wherein the input to the magnetic gear unit is rotationally coupled to an outer edge of the turbine.

5. The generator of claim 4 wherein the output of the magnetic gear unit comprises a plurality of circumferentially disposed magnets, and wherein the generator comprises at least one wire coil disposed proximate the circumferentially disposed magnets so as to have electric current induced therein by rotation of the magnets.

6. The generator of claim 5 wherein the at least one wire coil is disposed radially inwardly of the circumferentially disposed magnets.

7. The generator of claim 1 wherein the input to the magnetic gear unit is rotationally coupled to an inner edge of the turbine.

8. The generator of claim 7 wherein the output of the magnetic gear unit comprises a plurality of circumferentially disposed magnets, and wherein the generator comprises at least one wire coil disposed proximate the circumferentially disposed magnets so as to have electric current induced therein by rotation of the magnets.

9. The generator of claim 8 wherein the at least one wire coil is disposed radially inwardly of the circumferentially disposed magnets.

10. The generator of claim 1 wherein the at least one magnetic gear unit comprises a plurality of circumferentially disposed magnets coupled to the input, a plurality of circumferentially disposed magnets coupled to the output and substantially coaxial with the input magnets, and a plurality of circumferentially spaced apart pole shoes disposed radially between the input magnets and the output magnets.

11. The generator of claim 10 wherein the output magnets are disposed radially outwardly from the input magnets.

12. The generator of claim 10 wherein the output magnets are disposed radially inwardly from the input magnets.

13. The generator of claim 10 wherein the input magnets are arranged in alternating magnetic polarity.

14. The generator of claim 10 wherein the output magnets are arranged in alternating magnetic polarity.

15. The generator of claim 10 further comprising a magnetic flux closure disposed radially proximate the input magnets and on a radially opposite side thereof to the pole shoes.

16. The generator of claim 10 wherein the pole shoes comprise magnetically permeable material.

17. The generator of claim 1 further comprising an eccentric drive rotationally coupled between the turbine and the input of the at least one magnetic gear unit, the eccentric configured to cause the input of the at least one magnetic gear to rotate cycloidally with respect to the output of the at least one magnetic gear unit.

18. A method for generating electric power, comprising:
moving a fluid past a turbine to cause rotation thereof;
coupling the turbine rotation to an input of a magnetic gear unit;
coupling output of the magnetic gear to an electric generator to cause rotation thereof at at least one of a greater speed than a rotation speed of the turbine and inversely related torque and a lower speed than the rotation speed of the turbine and inversely related torque.

19. The method of claim 18 wherein the turbine rotation is coupled to the magnetic gear unit input at an outer edge of the turbine.

20. The method of claim 18 wherein the turbine rotation is coupled to the magnetic gear unit input at an inner edge of the turbine.

21. The method of claim 18 wherein the coupling output comprises moving magnets forming an output member of the magnetic gear unit proximate at least one wire coil to cause the generating electric power.

22. The method of claim 18 further comprising causing the input of the magnetic gear unit to rotate cycloidally.
